(19) United States
(12) Patent Application Publication
(10) Pub. No.: US 2009/0096933 A1
(43) Pub. Date: Apr. 16, 2009

(54) METHOD AND APPARATUS FOR ADJUSTING IMAGE QUALITY

(75) Inventor: Tadahiko Iijima, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/252,131

(22) Filed: Oct. 15, 2008

(30) Foreign Application Priority Data
Oct. 16, 2007 (JP) 2007-269037

(51) Int. Cl. H04N 5/14

(52) U.S. Cl. 348/700; 348/571; 348/673; 348/E05.062

(57) ABSTRACT

An image-quality adjusting apparatus includes a display control unit configured to display on a display unit a plurality of image data that are each associated with a predetermined item for image-quality control and each have a different evaluation value as to an adjustment item, and an image-quality adjusting unit configured to adjust image quality of the plurality of image data displayed on the display unit in accordance with a user's operation.

### BACKGROUND OF THE INVENTION

1. Field of the Invention

The present invention relates to a user interface, more specifically, a user interface configured to adjust image quality.

2. Description of the Related Art

Many video display apparatuses are provided with an image adjusting function capable of changing image quality in accordance with a user's taste or a video object. For example, items for changing image quality include contrast, brightness, hue, and sharpness.

Since it is difficult for a user to adjust and set each item to his or her favorite image quality, some image quality adjusting functions are provided with a plurality of items having previously set values. For example, the user can alter image quality into the quality previously-adjusted by the product maker by switching a mode into a standard mode, cinema mode, dynamic mode and the like.

However, when the user adjusts the image quality, for example, while watching a target video image currently on air, the user cannot simultaneously check and confirm the image quality of a plurality of images. Therefore, the user cannot compare the images to determine the best image quality.

As a method for solving a problem as described above, Japanese Patent Application Laid-Open No. 9-214853 discusses a method for determining the image quality to be viewed. According to the method, a displayed image is divided into a plurality of regions and the image quality can be independently set to each region.

Further, Japanese Patent Application Laid-Open No. 11-102428 discusses a method according to which a predetermined number of images is obtained from moving images and displayed in a form of a list. When an image is selected from the list, the image is converted using specified parameters step-by-step and a plurality of converted images are simultaneously displayed. Thus, a user can select the image quality of the video to be viewed.

Furthermore, Japanese Patent Application Laid-Open No. 2002-218350 discusses a method of adjusting image quality, according to which a part of input image is cropped and a plurality of cropped images are aligned to constitute one screen. By the method, image-quality adjustment is independently performed on each of the images.

However, according to the technology discussed in Japanese Patent Application Laid-Open No. 9-214853, since the image is divided into the plurality of regions and the image quality is independently set to each region, a video image is likely to cause trouble in viewing if a scene of the video is greatly changed after the image quality is adjusted and determined.

Further, according to the techniques discussed in Japanese Patent Application Laid-Open Nos. 11-102428 and 2002-218350, since the quality of a momentary image (i.e., still image) is adjusted, when a display varies, for example, a scene of the video is greatly changed, a video image is likely to cause trouble in viewing.

### SUMMARY OF THE INVENTION

An object of the present invention is directed to an image-quality adjusting apparatus capable of simply setting appropriate image quality to any characteristic image data.

According to an aspect of the present invention, an image-quality adjusting apparatus includes a display control unit configured to display on a display unit a plurality of image data that are each associated with a predetermined item for controlling image quality and each have a different evaluation value as to an adjustment item, and an image-quality adjusting unit configured to adjust image quality of the plurality of image data displayed on the display unit in accordance with a user's operation.

According to exemplary embodiments of the present invention, it is possible to simply set appropriate image quality to any characteristic image data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an external configuration of a video display apparatus according to a first exemplary embodiment of the present invention.

FIG. 2 is a block diagram illustrating a functional configuration of the video display apparatus according to the first exemplary embodiment of the present invention.

FIG. 3 is a flowchart illustrating processing for adjusting image quality performed by the video display apparatus according to a first exemplary embodiment of the present invention.

FIG. 4 is a diagram illustrating a transition state of display screens caused by the processing illustrated in the flowchart in FIG. 3.

FIG. 5 is a flowchart illustrating processing for adjusting the image quality performed by the video display apparatus according to a second exemplary embodiment of the present invention.

FIG. 6 is a diagram illustrating a transition state of display screens generated by the processing of the flowchart in FIG. 5.

FIG. 7 is a flowchart illustrating processing for adjusting the image quality performed by the video display apparatus according to a third exemplary embodiment of the present invention.

FIG. 8 is a diagram illustrating a transition state of display screens generated by the processing of the flowchart in FIG. 7.

FIG. 9 is a flowchart illustrating processing for adjusting the image quality performed by the video display apparatus according to a fourth exemplary embodiment of the present invention.

FIG. 10 is a diagram illustrating a transition state of display screens generated by the processing of the flowchart in FIG. 9.

FIG. 11 is a block diagram illustrating a functional configuration in which the video display apparatus and a video recording and reproduction apparatus according to a fifth exemplary embodiment of the present invention are connected to each other.

FIG. 12 is a flowchart illustrating a flow of processing of the video display apparatus and the video recording and reproduction apparatus according to the fifth exemplary embodiment of the present invention, when the video display apparatus and the video recording and reproduction apparatus are connected to each other.

FIG. 13 is a flowchart illustrating processing for adjusting the image quality performed by the video display apparatus according to the fifth exemplary embodiment of the present invention.

### DETAILED DESCRIPTION OF THE EMBODIMENTS

Various exemplary embodiments, features, and aspects of the invention will be described in detail below with reference to the drawings.

### First Exemplary Embodiment

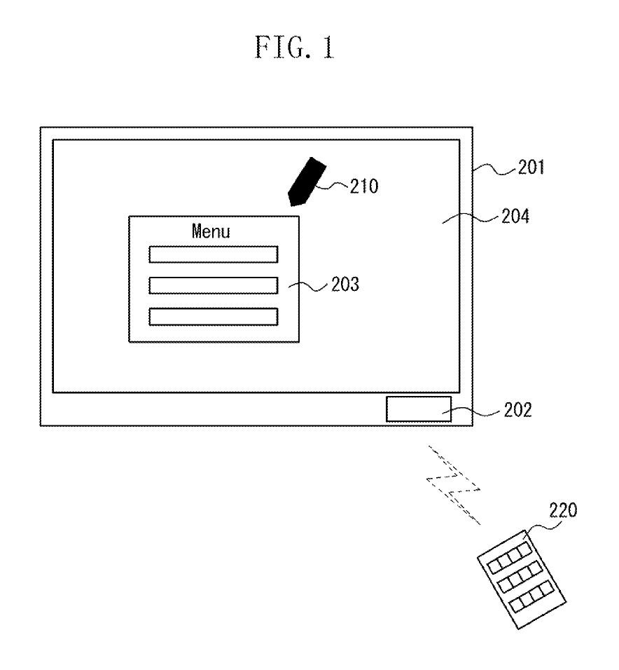

FIG. 1 is a diagram illustrating an external configuration of a video display apparatus 201 according to the first exemplary embodiment of the present invention.

The video display apparatus 201 displays an input video on a video display unit 204. A remote-control signal receiving unit 202 receives a signal of remote controller 220. A menu screen 203 is an On Screen Display (OSD) performed in response to a menu display signal received from a remote controller 220.

A menu screen 203 can be operated via the remote controller 220. A pen 210 can input a coordinate to the video display apparatus 201 and also operate the menu screen 203. The video display apparatus 201 is one of application examples of an image-quality adjusting apparatus according to the exemplary embodiment of the present embodiment.

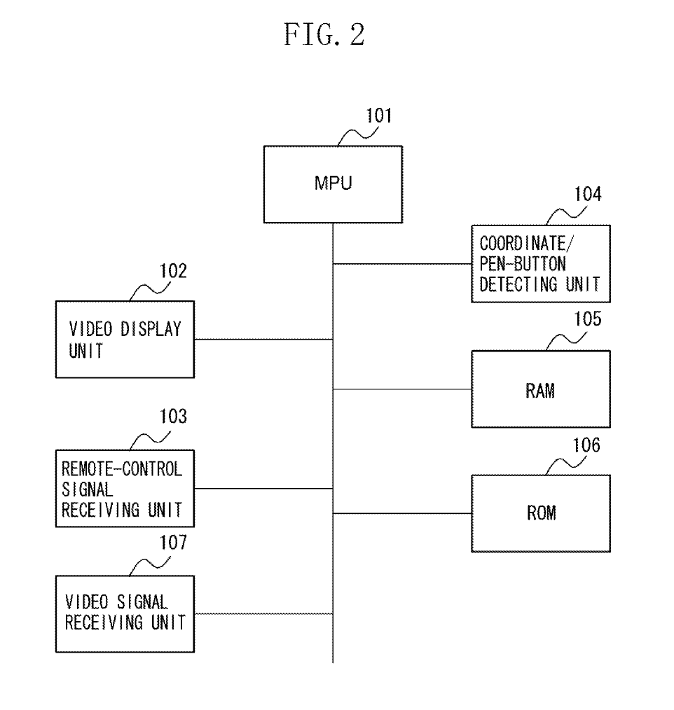

FIG. 2 is a block diagram illustrating a functional configuration of the video display apparatus 201 illustrated in FIG. 1. In FIG. 2, a video display unit 102 (corresponding to the video display unit 204 in configuration illustrated in FIG. 1) displays a video image. A remote-control signal receiving unit 103 receives the signal of the remote controller 220 (corresponding to the remote-control signal receiving unit 202 in configuration illustrated in FIG. 1). A coordinate/pen-button detecting unit 104 detects an input coordinate and pen-button signal of the pen 210.

A video signal receiving unit 107 receives a video signal. A micro processing unit (MPU) 101 performs control of various kinds of input/output, data processing and the like. A random access memory (RAM) 105 temporarily stores calculation results or data. A ROM 106 stores programs and data (including image data) that perform control according to the exemplary embodiments of the present invention.

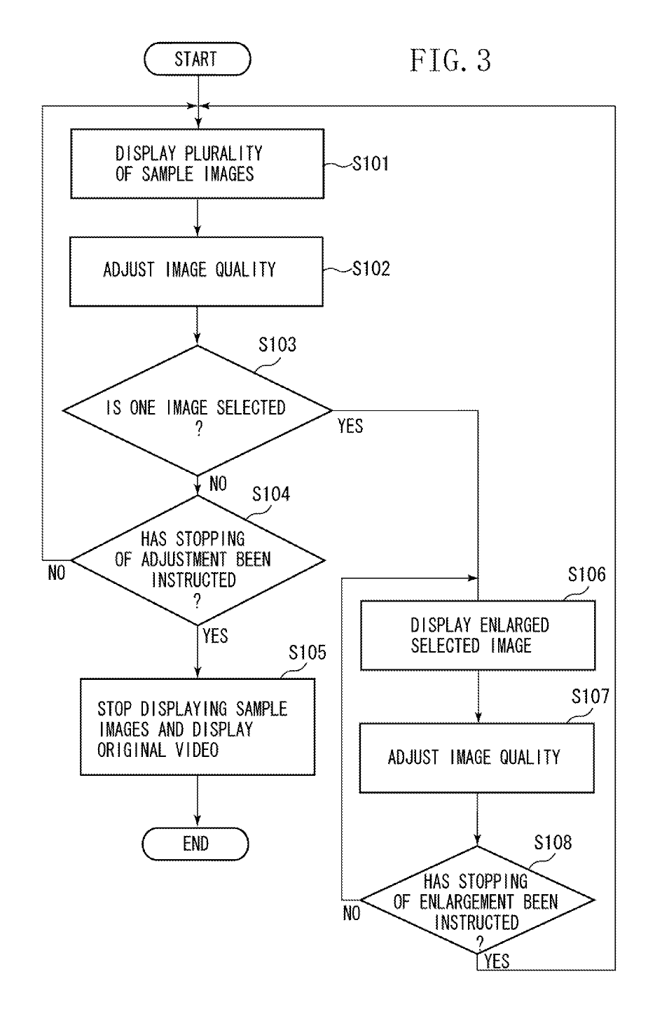

FIG. 3 is a flowchart illustrating processing for adjusting image quality performed by the video display apparatus 201 according to the present exemplary embodiment.

In step S101, the MPU 101 displays on the video display unit 102 a plurality of characteristic sample image data (hereinafter, simply referred to as a “sample image”) that have been previously prepared, in adjusting the image-quality. At this point, the MPU 101 reduces an image that has a large size, for a display.

The sample images to be displayed may be an image including a small light in a dark background, an image including many small letters, an image like a cartoon instead of a photo, an image having a large white region with snow, and an image including a large face of a person. The MPU 101 simultaneously displays these images on one screen.

The MPU 101 displays a menu for adjusting the image quality on the video display unit 102 while a plurality of sample images is displayed. A user can select a desired item on the menu for adjusting the image quality. In step S102, the MPU 101 adjusts the image quality of a specified item in accordance with the user's operation.

The items for the image-quality adjustment include, for example, contrast, brightness, hue, sharpness, color temperature, gain, gamma, color gamut and noise reduction. The images that are particularly affected by such items are used as sample images to be displayed in step S101.

For example, in a case of contrast, it is useful that images having a large difference in a contrast ratio are used as the sample images. This is because the image quality of adjusted contrast varies depending on a difference between the maximum value and minimum value of brightness in the image.

Further, an image having an average value of the brightness that is different from a variance value can be used as the sample image. Furthermore, in a case of sharpness, it is useful that images having different spatial frequencies be used as the sample images. Since image characteristics affected by the adjustment items varies depending on the adjustment items, it is useful that a combination of images having various characteristics described above be used as the sample images.

In step S103, the MPU 101 determines whether one sample image is selected from among a plurality of sample images (hereinafter, a plurality of sample images are referred to as a “set of sample images”) by user's operation.

When the user selects one sample image from among a set of sample images via the remote controller 220 or the pen 210 (YES in step S103), in step S106, the MPU 101 enlarges the selected sample image and displays the enlarged sample image on a screen. In step S107, the user checks details of the enlarged sample image and performs an operation for adjusting the image quality so that the MPU 101 performs the image-quality adjustment according to the operation.

In step S108, the MPU 101 determines whether an instruction to stop enlargement is given by user's operation. When the user has given the instruction to stop enlargement via the remote controller 220 or the pen 210 (YES in step S108), the processing returns to step S101 and the MPU 101 displays a plurality of sample images.

On the other hand, if the MPU 101 determines that the user has not given the instruction to stop enlargement (NO in step S108), the MPU 101 repeats the processing from step S106.

If one sample image is not selected from among the set of sample images (NO in step S103), in step S104, the MPU 101 determines whether an instruction to stop the image-quality adjustment is given.

If the instruction to stop the image-quality adjustment is given by the user via the remote controller 220 or the pen 210 (YES in step S104), in step S105, the MPU 101 stops displaying the sample image and displays the original video, and stores an adjusted parameter value in the RAM 105.

On the other hand, if the MPU 101 determines that the instruction to stop the image-quality adjustment is not given (NO in step S104), the processing returns to step S101.

By adjusting the image quality according to the method described above, the user can adjust the image quality while watching the set of all characteristic sample images. More specifically, since a result of adjusting the image quality is reflected to all sample images among the set of sample images, it is not likely that while some images are clearly viewed, other images are unclearly viewed due to a deviated image quality.

An example according to the present exemplary embodiment describes the method of operating the screen via the remote controller 220 and pen 210 while the OSD is displayed. However, the present invention is not limited to the method, but is also applicable to an operation of transmitting/receiving commands to/from other computers via the network.

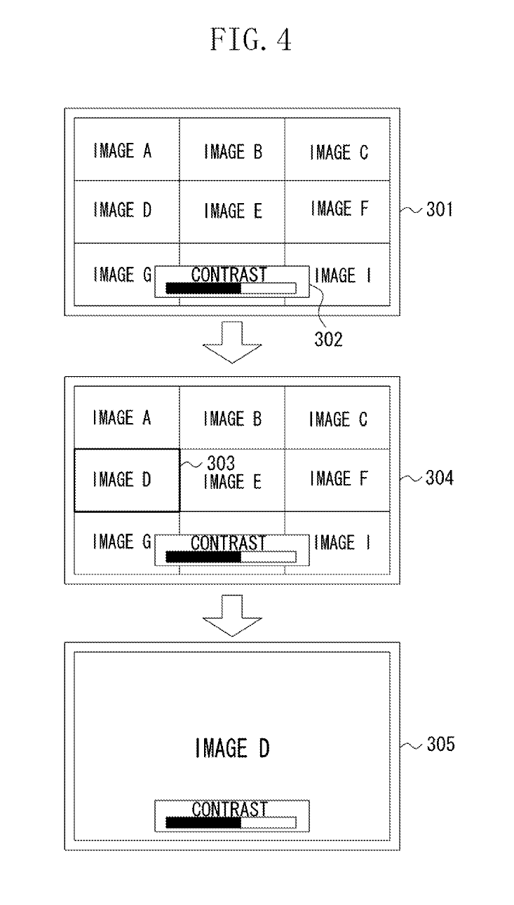

FIG. 4 is a diagram illustrating a transition state of display screens generated by the processing of the flowchart in FIG. 3. A state 301 illustrates a display screen showing the set of sample images for adjusting contrast. An OSD 302 allows a user to visually recognize a contrast-adjusting value.

A state 304 illustrates a display screen on which a sample image D is selected so that the user can enlarge the sample image and check details thereof. In the state 304 of a display screen, the sample image D selected in step S103 is surrounded with a frame 303 so that the user can identify the sample image D.

When selecting a sample image, the user may select the sample image via the remote controller 220 or by directly touching the display screen with the pen 210. In a state 305 of a display screen, contrast of the sample image D is enlarged in step S106 and is being adjusted after the sample image D has been selected.

### Second Exemplary Embodiment

Next, the second exemplary embodiment of the present invention will be described. Since the system configuration of the video display apparatus 201 according to the second exemplary embodiment is similar to the first exemplary embodiment as shown in FIGS. 1 and 2, the description of the system configuration is omitted.

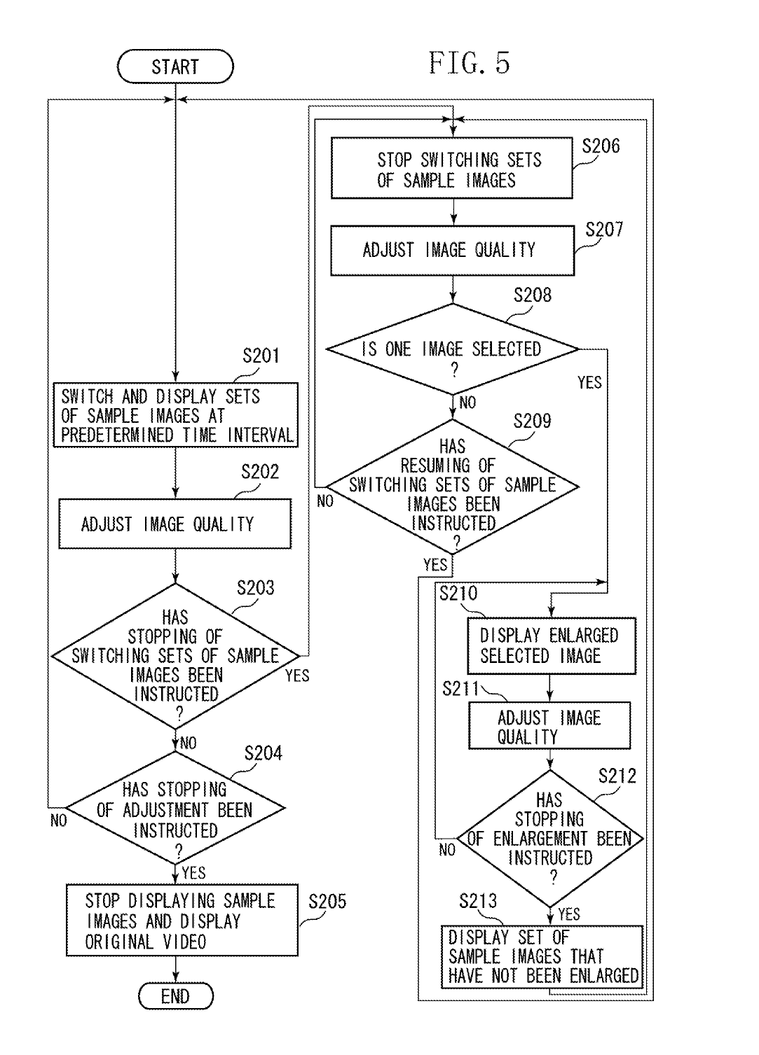

FIG. 5 is a flowchart illustrating processing for adjusting the image quality performed by the video display apparatus 201 according to the second exemplary embodiment of the present invention. In the processing for adjusting the image quality according to the present exemplary embodiment, sets of sample images are switched at a predetermined time interval to adjust the image quality.

In step S201, when the image-quality is adjusted, the MPU 101 displays on one screen of the video display unit 102 the set of characteristic sample images that have been previously prepared. At this point, the MPU 101 reduces an image that has a large size, for a display.

The set of sample images to be displayed may be an image including a small light in a dark background, an image including many small letters, an image like a cartoon instead of a photo, an image including a large white region with snow, and an image including a large face of a person. The MPU 101 simultaneously displays these images on one screen.

In step S201, when displaying the set of sample images, the MPU 101 repeats processing of sequentially switching and displaying the sets of sample images at the predetermined time interval.

The user can select a desired item on the menu for adjusting the image quality. Instep S202, the MPU 101 performs the image-quality adjustment in accordance with the operation.

The items for the image-quality adjustment include, for example, contrast, brightness, hue, sharpness, color temperature, gain, gamma, color gamut and color strength. It is useful that the images which are particularly affected by such items are used as sample images to be displayed in step S201.

In step S203, the MPU 101 determines whether an instruction to stop switching the sets of sample images is given by the user's operation. If the instruction to stop switching the sample images is given (YES in step S203), in step S206, the MPU 101 stops switching the sample images. In step S207, the MPU 101 adjusts the image quality while switching of the sets of sample images is stopped.

In step S208, the MPU 101 determines whether one sample image is selected from among the set of sample images when switching the sets of sample images is stopped. If one sample image is selected (YES in step S208), in step S210, the MPU 101 enlarges the selected sample image and displays the enlarged image on the screen.

The user checks details in the enlarged image and performs the image-quality adjusting operation. In step S211, the MPU 101 performs the image-quality adjustment in accordance with the operation.

In step S212, the MPU 101 determines whether an instruction to stop enlargement is given by the user's operation. If the instruction to stop enlargement is given by the user via the remote controller 220 or the pen 210 (YES in step S212), in step S213, the MPU 101 displays the plurality of sample images that have not been enlarged, and the processing returns to step S206.

On the other hand, if the instruction to stop enlargement is not given by the user (NO in step S212), the processing returns to S210 and continues to display the enlarged sample image that has been selected.

If the MPU 101 determines that one sample image is not selected from among the set of the sample images in S208 (NO in step S208), in the step S209, the MPU 101 determines whether resuming of switching the sets of sample images is instructed.

If resuming of switching the sample images is instructed by the user via the remote controller 220 or the pen 210 (YES in step S209), the processing returns to S201, and the MPU 101 switches and displays the plurality sets of sample images at the predetermined time interval.

On the other hand, if resuming of switching the sample images is not instructed (NO in step S209), the processing returns to step S206 and the MPU 101 retains a state where switching the sets of sample images is stopped.

If the instruction to stop switching the sample images is not given in step S203 (NO in step S203), in step S204, the MPU 101 determines whether stopping of the image-quality adjustment is instructed.

If stopping of the image-quality adjustment is instructed by the user in S204 (YES in step S204), in step S205, the MPU 101 stops displaying the sample image and displays the original video image, and stores an adjusted parameter value in the RAM 105.

On the other hand, if the MPU 101 determines that stopping of the image-quality adjustment is not instructed in step S204 (NO in step S204), the processing returns to step S201.

By adjusting the image quality according to the method described above, the user can adjust the image quality while watching the set of all characteristic sample images. More specifically, since a result of adjusting the image quality is reflected to all sample images among the set of sample images, it can be avoided that some images can be clearly viewed while other images are unclearly viewed due to the deviated image quality.

Particularly, since the user can check more sample images to adjust the image quality than in the first exemplary embodiment, according to the second exemplary embodiment, it is easier to set appropriate image quality than in the first exemplary embodiment.

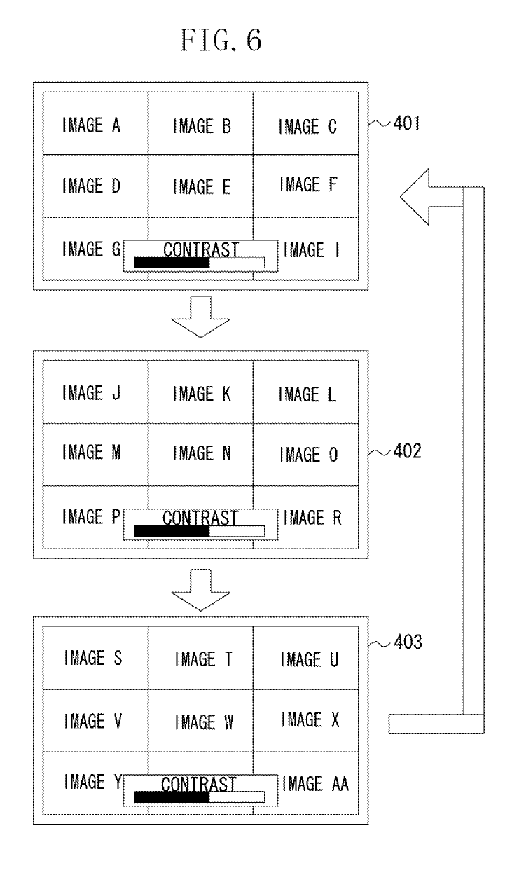

FIG. 6 is a diagram illustrating a transition state of display screens generated by processing of the flowchart in FIG. 5.

A state 401 illustrates a display screen with the set of sample images displayed for adjusting the contrast. A state 402 illustrates a display screen on which a set of sample images have switched to a different set of sample images after a predetermined time has passed since the state 401 of the display screen is displayed.

A state 403 illustrates a display screen on which the set of sample images have changed to a different set of sample images when the predetermined time has passed since the state of the display screen 402 was displayed.

If switching of the sets of sample images is stopped, any one of the states 401, 402, and 403 of the display screens is not switched even when the predetermined time has passed. The present exemplary embodiment describes three sets of sample images, however, the present invention is not limited to three sets.

When switching of the sets of sample images is stopped, the user can select and enlarge the sample image to check the image quality. The screen on which the sample image to be enlarged is selected is similar to FIG. 4.

When enlarging of the sample image is cancelled, in step S213, the display screen displays the set of sample images which are not enlarged and the state shifts to that in step S206 where the set of sample images are not switched. When switching the sets of sample images is instructed, the display screen displays the state in step S201 where the sets of sample images are to be switched.

In the present exemplary embodiment, the example describes a transition to the state in which enlarging of the sample image is stopped when switching of the sets of sample images is cancelled. However, the present invention is not limited to this exemplary embodiment. The display may also shift to a state where the sets of sample images are switched. Further, the sample image may be selected and enlarged in a state where the sets of sample images are switched.

The example describes the method for operating the menu screen 203 (OSD) to specify an item with the remote controller 220 or the pen 210, however, the present invention is not limited to that method. A method for operating the menu screen 203 by transmitting/receiving commands to/from other computers via the network can also be applied.

### Third Exemplary Embodiment

Next, the third exemplary embodiment of the present invention will be described. Since the system configuration of the video display apparatus 201 according to the present exemplary embodiment is similar to the first exemplary embodiment as shown in FIGS. 1 and 2, the descriptions are omitted.

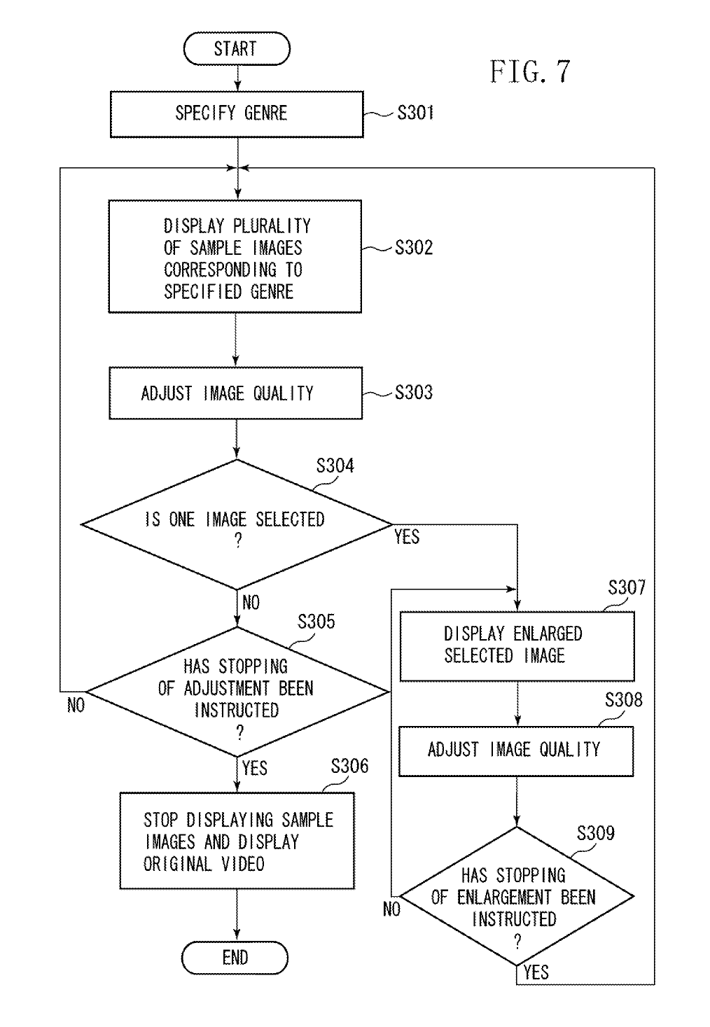

FIG. 7 is a flowchart illustrating processing for adjusting the image quality performed by the video display apparatus 201 according to the third exemplary embodiment of the present invention.

The processing for adjusting the image quality according to the present exemplary embodiment particularly specifies a genre (category) to be viewed and changes the sets of sample images according to a specified genre to adjust the image quality.

A user specifies a genre close to a content to be viewed from among genres previously prepared in a state of the image-quality adjustment. In step S301, the MPU 101 selects the genre in response to the specification.

In step S302, the MPU 101 displays on one screen a set of sample images highly likely to be displayed in a genre selected from among characteristic sample images previously prepared in step S301, that is, a plurality of sample images associated with the selected genre. At this point, the MPU 101 reduces an image that has a large size, for a display.

The sample images to be displayed may be an image including a small light in a dark background, an image including many small letters, an image like an anime cartoon instead of a photo, an image including a large white region with snow, an image including a large face of a person. The MPU 101 simultaneously displays these images on one screen.

By adding information about the genre that is relevant to the sample images previously prepared, the set of sample images associated with the genre can be generated.

The MPU 101 displays the menu for adjusting the image quality while the set of sample images is displayed. The user can select a desired item on the menu for adjusting the image quality. In step S303, the MPU 101 adjusts the image quality of a specified item in accordance with the user's operation.

The items for the image-quality adjustment include, for example, contrast, brightness, hue, sharpness, color temperature, gain, gamma, color gamut and noise reduction. The images that are particularly affected by such items are used as sample images to be displayed in step S302.

In step S304, the MPU 101 determines whether one sample image is selected from among the set of sample images by user's operation. When the user selects one sample image from among a set of sample images with the remote controller 220 or the pen 210 (YES in step S304), in step S307, the MPU 101 enlarges the selected sample image and displays the enlarged sample image on the screen.

In step S308, the user checks details of the enlarged sample image and performs an operation for adjusting the image quality so that the MPU 101 adjusts the image quality according to the operation.

In step S309, the MPU 101 determines whether stopping of enlargement is instructed by user's operation. When stopping of enlargement is instructed by the user with the remote controller 220 or the pen 210 (YES in step S309), the processing returns to step S302 and the MPU 101 displays the set of sample images corresponding to the specified genre.

On the other hand, if the MPU 101 determines that stopping of enlargement is not instructed by the user (NO in step S309), the MPU 101 repeats the processing from step S307.

If one sample image is not selected from among the set of sample images in step S304 (NO in step S304), in step S305, the MPU 101 determines whether stopping of the image-quality adjustment is instructed.

If stopping of the image-quality adjustment is instructed by the user with the remote controller 220 or the pen 210 (YES in step S305), in step S306, the MPU 101 stops displaying the sample image and displays the original video image, and stores an adjusted parameter value in the RAM 105. On the other hand, if the MPU 101 determines that stopping of the image-quality adjustment is not instructed in step S305 (NO in step S305), the processing returns to step S302.

By adjusting the image quality according to the method as described above, the user can adjust the image quality while watching all sample images that have similar characteristics to the images displayed as the content of the specified genre.

More specifically, since the result of adjusting the image quality is reflected to all sample images associated with the specified genre, it can be avoided that while some images can be clearly viewed, other images are unclearly viewed due to deviated image quality, when the contents of the specified genre is viewed.

According to the present embodiment, the processing similar to the first exemplary embodiment is performed after the genre is specified. However, the present invention is not limited to the processing, but the processing similar to the second exemplary embodiment may be also performed after the genre is specified.

Here, the example describes the method of operating the menu screen 203 (OSD) with the remote controller 220 and pen 210. However, the present invention is not limited to the method as described above. A method of transmitting/receiving commands to/from other computers via the network can also be applied.

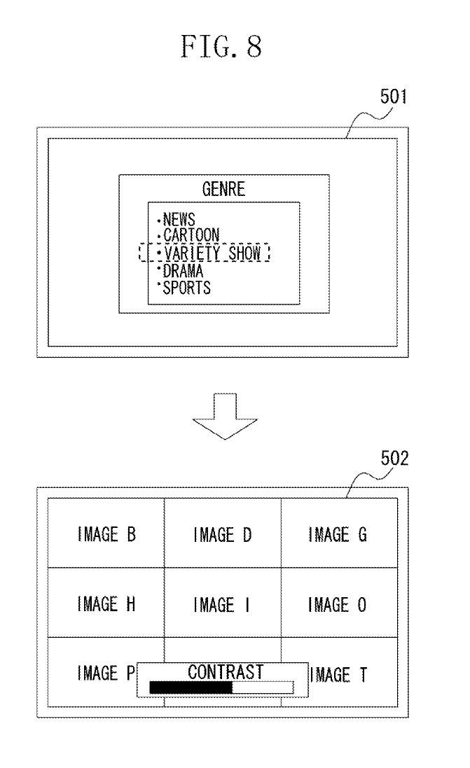

FIG. 8 is a diagram illustrating a transition state of display screens generated by processing of the flowchart in FIG. 7. A state 501 illustrates a display screen in step S301 for selecting the genre.

The display screen displays a menu of the OSD so that the genre can be selected. For example, the display screen displays the genre such as news, cartoon, variety show, drama, and sports, and receives an operation for selecting the genre.

The state 502 illustrates a display screen in step S303 on which the set of sample images associated with the genre is displayed after the genre has been determined to adjust contrast.

### Fourth Exemplary Embodiment

Next, the fourth exemplary embodiment of the present invention will be described. Since the system configuration of the video display apparatus 201 according to the present exemplary embodiment is similar to the first exemplary embodiment as shown in FIGS. 1 and 2, the descriptions are omitted.

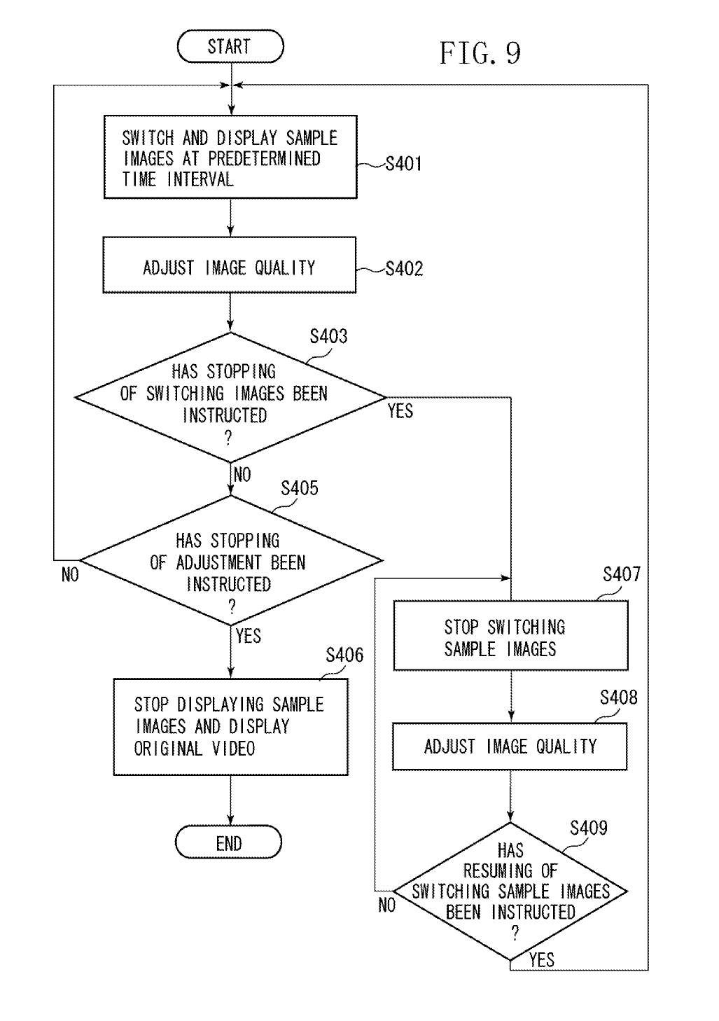

FIG. 9 is a flowchart illustrating processing for adjusting the image quality performed by the video display apparatus 201 according to the fourth exemplary embodiment of the present invention.

The processing for adjusting the image quality according to the present invention is not performed by displaying the set of sample images on one screen but performed by displaying one sample image on the screen and switching the displayed sample images at a predetermined time interval to adjust the image quality.

In step S401, the MPU 101 displays one characteristic sample image that has been previously prepared, on the screen of the video display unit 102 when the image-quality is adjusted, and switches the displayed sample images at the predetermined time interval.

The sample images to be displayed may be an image including a small light in a dark background, an image including many small letters, an image like an anime cartoon instead of a photo, an image including a large white region with snow, and an image including a large face of a person.

The MPU 101 displays the menu for adjusting the image quality while the sample image is displayed. The user can select a desired item on the menu to adjust the image quality. In step S402, the MPU 101 adjusts the image quality of a specified item in accordance with the user's operation.

The items for the image-quality adjustment may include, for example, contrast, brightness, hue, sharpness, color temperature, gain, gamma, color gamut and noise reduction. The images that are particularly affected by such items are used as sample images to be displayed in step S401.

In step S403, the MPU 101 determines whether stopping of switching the sample images is instructed by the user. If stopping of switching the sample images is instructed by the user (YES in step S403), in step S407, the MPU 101 stops switching of the sample images. Next, in step S408, the MPU 101 adjusts the image quality in accordance with the user's operation in a state where switching of the sample images is stopped.

In step S409, the MPU 101 determines whether resuming of switching of the sample images is instructed by the user. If resuming of switching of the sample images is instructed by the user with the remote controller 220 or the pen 210 (YES in step S409), the processing returns to step S401, and the MPU 101 switches and displays the sample images at the predetermined time interval.

On the other hand, if resuming of switching of the sample images is not instructed (NO in step S409), the processing returns to S407 and the MPU 101 continues a state where switching of the sets of sample images is stopped.

If the MPU 101 determines that resuming of switching of the sample images is not instructed by the user in step S403 (NO in step S403), the MPU 101 determines whether stopping of the image-quality adjustment is instructed in step S405.

If the image-quality adjustment is instructed by the user via the remote controller 220 or the pen 210 (YES in step S405), in step S406, the MPU 101 stops displaying the sample image and displays the original video image, and stores an adjusted parameter value in the RAM 105.

On the other hand, if the image-quality adjustment is not instructed (NO in step S405), the processing returns to step S401 and the MPU 101 switches and displays the sample images at the predetermined time interval.

By adjusting the image quality according to the method as described above, the user can adjust the image quality while watching the all characteristic sample images. More specifically, since a result of adjusting the image quality is reflected to all sample images, it can be avoided that some images are clearly viewed while other images are unclearly viewed due to deviated image quality.

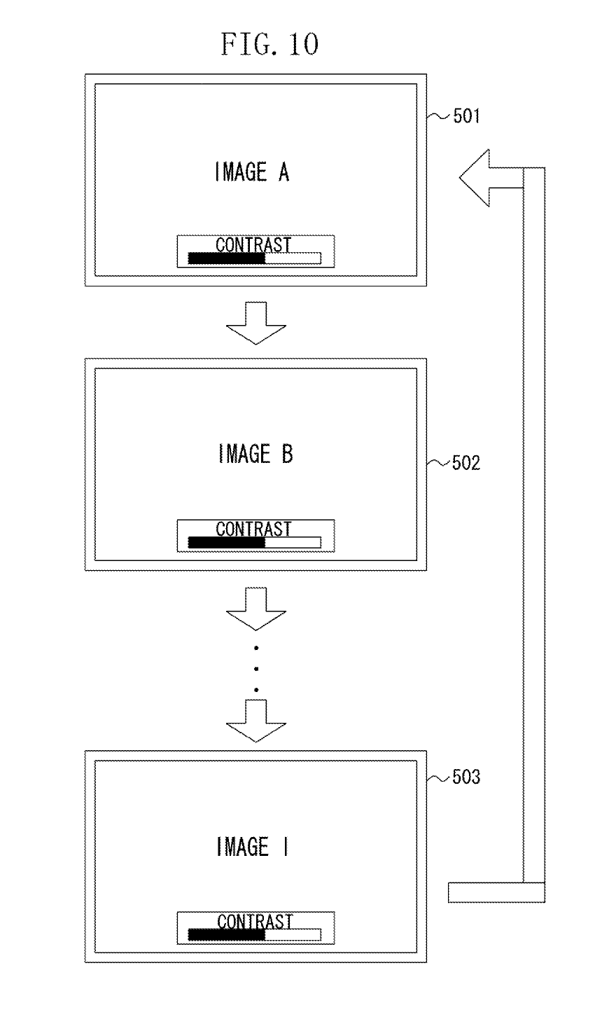

FIG. 10 is a diagram illustrating a transition state of display screens generated by the processing of the flowchart in FIG.9. FIG. 10 illustrates that the sample images in the states 501, 502 and 503 are switched at a predetermined time interval and contrast of the sample images are adjusted.

An example according to the present exemplary embodiment describes the method of operating the screen via the remote controller 220 and the pen 210 while the OSD is displayed. However, the present invention is not limited to the method, but is also applicable to a method of transmitting/receiving commands to/from other computers via the network.

### Fifth Exemplary Embodiment

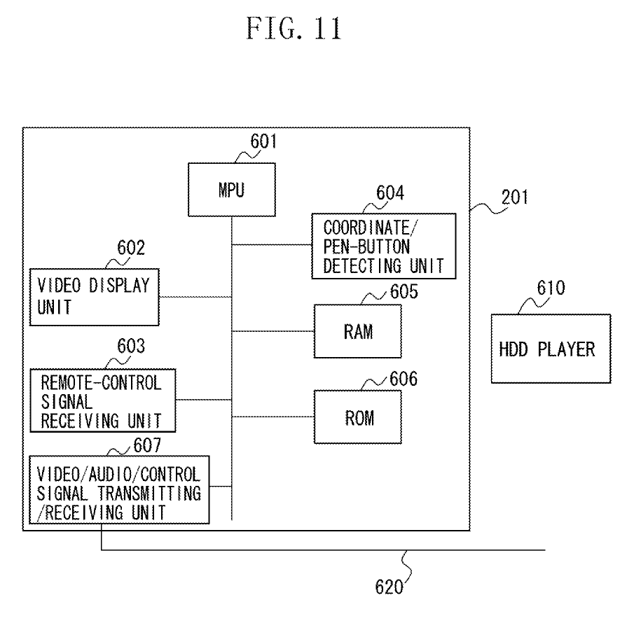

Next, the fifth exemplary embodiment of the present invention will be described. FIG. 11 is a block diagram illustrating a functional configuration when the video display apparatus 201 and a video recording and reproduction apparatus 610, for example hard disk drive (HDD) player) according to fifth exemplary embodiment of the present invention are connected to each other.

In FIG. 11, a video display unit 602 displays a video image. A remote-control signal receiving unit 603 receives a signal of the remote controller 220. A coordinate/pen-button detecting unit 604 detects an input coordinate and a pen-button signal of the pen 210. A video/audio/control signal transmitting/receiving unit 607 carries out communication by exchanging video, audio and control signals with a video recording and reproduction apparatus 610 that records and reproduces the video.

An MPU 601 performs control of various kinds of input/output, data processing and the like. A random access memory (RAM) 605 temporarily stores calculation results or data. A ROM 606 stores programs and data (including image data) that perform control according to the exemplary embodiments of the present invention.

Further, the video recording and reproduction apparatus 610 is connected to the video display apparatus 201 by a high-definition multimedia interface (HDMI) cable 620 that is a communication line.

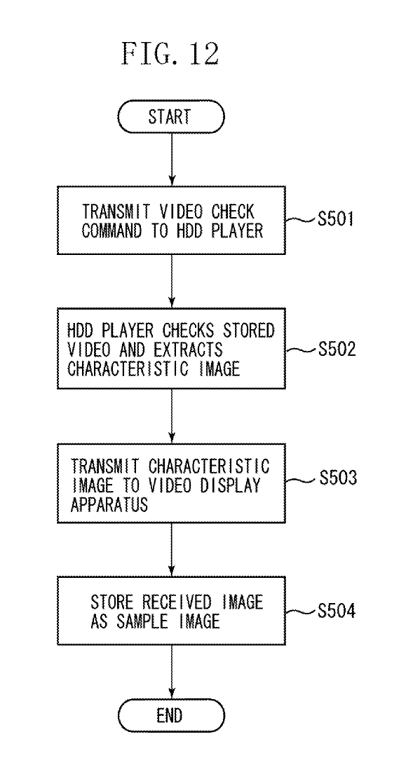

FIG. 12 is a flowchart illustrating a flow of processing of the video display apparatus 201 and the video recording and reproduction apparatus 610, when the video display apparatus 201 is connected to the video recording and reproduction apparatus 610.

In step S501, the MPU 601 transmits a video check command to the video recording and reproduction apparatus 610 via the HDMI cable 620 when the video display apparatus 201 is connected to the video recording and reproduction apparatus 620 by the HDMI cable 620.

In step S502, the video recording and reproduction apparatus 610 that has received the command checks the stored vide image and extracts a characteristic image or an image in which a scene change occurs. Next, in step S503, the video recording and reproduction apparatus 610 transmits the extracted image to the video display apparatus 201.

In step S504, the MPU 601 in the video display apparatus 201 that receives the video image stores the image as a characteristic sample image in the RAM 605. The MPU 601 uses the stored image as the sample image for adjusting the image quality. As the sample image for adjusting the image quality, any sample images described in the first to fourth exemplary embodiments may be used.

The present exemplary embodiment describes the video recording and reproduction apparatus 610 that checks the video and extracts the characteristic image. Alternatively, the video recording and reproduction apparatus 610 may transmit a picture-index image stored therein and store the picture-index image as the sample image.

The present exemplary embodiment describes a HDD player that is the video recording and reproduction apparatus 610. However, the present invention is not limited to the HDD player, instead, a storing medium such as a digital versatile disc (DVD) player, a memory card, and a VIDEO player may also be used.

Further, the connecting cable is not limited to the HDMI cable, but any connecting cable capable of transmitting and receiving the video and control signals may also be used.

Further, the connecting cables may be individually provided in order to respectively transmit and receive the video and control signals. Furthermore, according to the present exemplary embodiment, transmission of the command is started when the connecting cable is connected, however, the transmission of the command may also be started at different timing.

### Sixth Exemplary Embodiment

Next, the sixth exemplary embodiment will be described. Since the system configuration of the video display apparatus 201 according to the present exemplary embodiment is similar to the first exemplary embodiment as shown in FIGS. 1 and 2, the description of the system configuration is omitted.

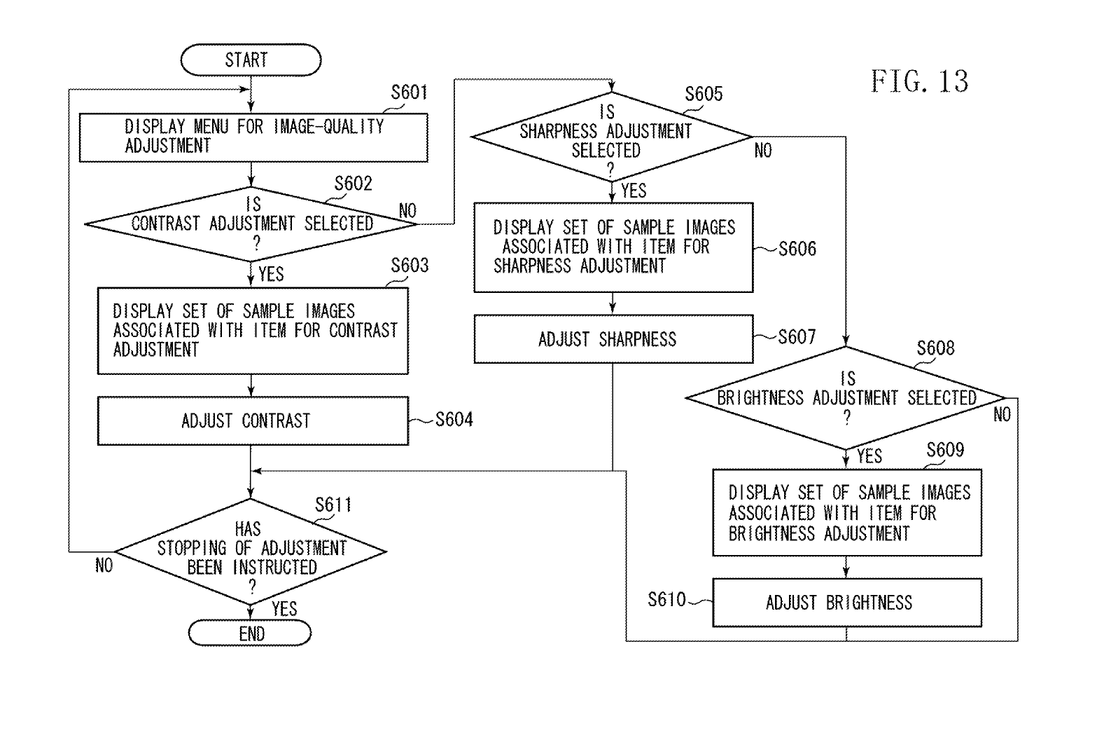

FIG. 13 is a flowchart illustrating processing for adjusting the image quality performed by the video display apparatus 201 according to the fifth exemplary embodiment of the present invention. The processing for adjusting the image quality according to the present exemplary embodiment is carried out by switching the sets of the sample images depending on the item for adjusting the image quality.

In step S601, the MPU 101 displays the menu for adjusting the image quality on the video display unit 102 when the image-quality is adjusted. The MPU 101 selects an item to be adjusted in accordance with the user's operation.

In step S602, the MPU 101 determines whether the contrast adjustment is selected by user's operation of selection. If the contrast adjustment is selected by the user (YES in step S602), in step S603, the MPU 101 displays on the video display unit 102 a set of sample images associated with the item for the contrast adjustment. In step S604, the MPU 101 adjusts contrast in accordance with the user's operation.

On the other hand, if the contrast adjustment is not selected in step S602 (NO in step S602), in step S605, the MPU 101 determines whether sharpness adjustment is selected as an item for adjusting the image quality by the user's operation.

If the sharpness adjustment is selected as the item for the image-quality adjustment (YES in step S605), in step S606, the MPU 101 displays a set of sample images associated with the item for the sharpness adjustment. In step S607, the MPU 101 adjusts sharpness in accordance with the user's operation.

If the sharpness adjustment is not selected in step S605 (NO in step S605), in step S608, the MPU 101 determines whether brightness adjustment is selected as an item for adjusting the image quality by the user's operation.

If the brightness adjustment is selected as the item for adjusting the image quality (YES in step S608), in step S609, the MPU 101 displays a set of sample images associated with the item for the brightness adjustment. In step S610, the MPU 101 adjusts brightness in accordance with the user's operation.

If after steps S604, S607 and S610, or in step S608, the brightness adjustment is not selected as the item for adjusting the image quality (NO in step S608), the processing proceeds to step S611. In step S611, the MPU 101 determines whether stopping of the image-quality adjustment has been instructed.

If stopping of the image-quality adjustment is instructed (YES in step S611), the processing illustrated in FIG. 13 is stopped. On the other hand, if stopping of the image-quality adjustment is not instructed (NO in step S611), the processing returns to step S601 and the MPU 101 displays the menu for adjusting the image quality.

Examples of images associated with the item for the contrast adjustment may be an image of an object subjected to bright light in which light and shade portions appear, an image including a person in the darkness, an image including a small white bear with a background of snow, and a gray image having a gradation in a certain tone difference.

Alternatively, the item for the contrast adjustment may also be associated with other images such as an image having a contrast ratio larger than a predetermined contrast ratio, an image having a black area larger than a predetermined area and having a contrast ratio smaller than a predetermined contrast ratio, and an image having a white area larger than a predetermined area and having a contrast ratio smaller than a predetermined contrast ratio, and a gray image having a gradation in a specified tone difference.

Not all of the images as described above need to be associated with the item, but at least any two of such images may be associated with the item.

Examples of images associated with the item for the sharpness adjustment may be an image including a tree with a lot of leaves, an image including a letter written with black characters on white paper, an image including blue sky and sea, and an image of a person wearing a boarder shirt.

According to other points of view, the item for the sharpness adjustment may also be associated with an image having a first spatial frequency lower than a predetermined spatial frequency, an image having a second spatial frequency higher than a predetermined spatial frequency, and an image having a middle spatial frequency between the first and second spatial frequencies.

Similar to the above mentioned, all of the images does not need to be associated with the item, but at least any two of such images may be associated with the item.

Further, examples of images associated with the item for the brightness adjustment may be an image of an object subjected to bright light in which light and shade portions appear, an image including a person in the darkness, an image including a small white bear with a background of snow, and an image including stars in a dark background.

Further, according to other points of view, the item for adjusting brightness may also be associated with other images such as an image having a black area larger than a predetermined area and an image having a white area larger than a predetermined area

In the present embodiment, the examples of images associated with the items for contrast, sharpness, and brightness adjustments are described. However, the present invention is not limited to the examples as described above, but other adjustment items may be included. Further, the present invention is not limited to the example images associated with the adjustment items.

Each of the units and steps constituting the exemplary embodiments of the present invention as described above is realized by the operation of programs stored in RAM, ROM, and the like in the computer.

The present invention includes the program and the computer-readable storing medium that records the program.

Further, the present invention can be embodied, for example, as a system, apparatus, method, program, and storing medium, and can be applied to an apparatus constituted by one device.

The present invention provides the software program that realizes the functions of the exemplary embodiments as described above, directly or remotely to the system or apparatus. The present invention also includes the system or the computer of the apparatus that realizes the present invention itself by reading and performing the provided program codes.

Accordingly, the present invention is also realized by the program code itself installed in the computer to realize the functional processing according to the present invention. That is, the present invention also includes the computer program itself to realize the functional processing according to the present invention.

In that case, the program may be an object code, a program performed by an interpreter, script data to be supplied to an operating system, or the like, as long as the program code functions as a program.

Further, the computer executes read-out programs so that functions of the exemplary embodiments as described above are realized. Furthermore, an operating system (OS) that is running on the computer may perform a part or all of the actual processing based on the instructions of the programs so that the processing can realize the functions of the exemplary embodiments as described above.

Furthermore, according to another method, the program read out from the storing medium is written in a function-extending board inserted into the computer or a memory provided in a function-extending unit connected to the computer.

Based on the instruction of the program, a central processing unit (CPU) provided in the function extending board inserted into the computer or a memory provided in the function extending unit performs a part of or all of the actual processing. The processing performs the functions of exemplary embodiments as described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-269037 filed Oct. 16, 2007, which is hereby incorporated by reference herein in its entirety.

What is claimed is:

1. An image-quality adjusting apparatus comprising:
a display control unit configured to display on a display unit a plurality of image data,
wherein each of the plurality of image data is associated with a predetermined item for image-quality control and,
wherein each of the plurality of image data has a different evaluation value as to an adjustment item; and
an image-quality adjusting unit configured to adjust image quality of the plurality of image data displayed on the display unit in accordance with a user's operation.

2. The image-quality adjusting apparatus according to claim 1, wherein the display control unit simultaneously displays the plurality of image data.

3. The image-quality adjusting apparatus according to claim 1, wherein the display control unit sequentially switches the plurality of image data displayed on the display unit.

4. The image-quality adjusting apparatus according to claim 1, wherein the display control unit sequentially switches and displays the plurality of image data at a predetermined time interval.

5. The image-quality adjusting apparatus according to claim 1, further comprising a field selecting unit configured to select a field of the image data in accordance with a user's operation, wherein the display control unit displays the plurality of image data associated with the field selected by the field selecting unit.

6. The image-quality adjusting apparatus according to claim 1, wherein the display control unit sequentially switches and displays each of the image data on the display unit so as to display the plurality of image data on the display unit.

7. The image-quality adjusting apparatus according to claim 1, further comprising an image-quality item selecting unit configured to select an image-quality item to be adjusted according to the user's operation, wherein the display control unit displays the plurality of image data associated with the image-quality item selected by the image-quality item selecting unit.

8. The image-quality adjusting apparatus according to claim 7, wherein an item for adjusting contrast is associated with at least any two of the image data among image data having a contrast ratio larger than a predetermined contrast ratio, image data having a black area larger than a predetermined area and having a contrast ratio smaller than a predetermined contrast ratio, and image data having a white area larger than a predetermined area and having a contrast ratio smaller than a predetermined contrast ratio, and gray image data of gradation having a specified tone difference.

9. The image-quality adjusting apparatus according to claim 7, wherein an item for adjusting sharpness is associated with at least any two of the image data among image data having a first spatial frequency lower than a predetermined spatial frequency, image data having a second spatial frequency higher than a predetermined spatial frequency, and image data having a middle spatial frequency between the first and second spatial frequencies.

10. The image-quality adjusting apparatus according to claim 7, wherein an item for adjusting brightness is associated with an image data having a black area larger than a predetermined area and image data having a white area larger than a predetermined area.

11. The image-quality adjusting apparatus according to claim 1 further comprising an obtaining unit configured to obtain the plurality of image data from a recording apparatus connected via a communication line, wherein the display control unit displays on the display unit the image data obtained by the obtaining unit.

12. A method for an image-quality adjusting apparatus comprising:
displaying on a display unit a plurality of image data that are associated with a predetermined item for adjusting image-quality and have different evaluation values as to the items for adjustment; and
adjusting quality of the plurality of image data displayed on the display unit in accordance with a user's operation.

13. A computer-readable storage medium storing a computer-executable process, the computer-executable process causing a computer to implement the method of claim 12.

14. An image-quality adjusting apparatus comprising:
a detecting unit configured to detect a scene change from video data;
a determining unit configured to determine a scene-change image based on the scene change detected by the detecting unit;
a display control unit configured to display the scene-change image on a display unit; and
an image-quality adjusting unit configured to adjust image quality of the scene-change image displayed on the display unit in accordance with a user's operation.

15. A method for an image-quality adjusting apparatus comprising:
detecting a scene change from video data;
determining a scene-change image based on the detected scene change;
displaying the scene-change image on a display unit; and
adjusting image quality of the scene-change image displayed on the display unit in accordance with a user's operation.

16. A computer-readable storage medium storing a computer-executable process, the computer-executable process causing a computer to implement the method of claim 15.
